(19) United States
(12) Patent Application Publication
(10) Pub. No.: US 2006/0101152 A1
(43) Pub. Date: May 11, 2006

(54) Statistics engine

(75) Inventors: Tzong-Kwang Yeh, Palo Alto, CA (US); Tak Kwong Wong, Milpitas, CA (US); Sunil Kashyap, Campbell, CA (US); Trevor Hiatt, Morgan Hill, CA (US); Michael John Miller, Saratoga, CA (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Integrated Device Technology, Inc.

(21) Appl. No.: 11/257,910

(22) Filed: Oct. 24, 2005

Related U.S. Application Data
(60) Provisional application No. 60/622,273, filed on Oct. 25, 2004.

(51) Int. Cl. G06F 15/16

(52) U.S. Cl. 709/231

(57) ABSTRACT

A memory system that provides statistical functions is provided. The memory system includes a dual-port memory array where one port is coupled to a statistics processor. The statistics processor can perform statistical analysis on data stored in the dual-port memory array in response to opcode commands received from an external processor.

### RELATED APPLICATION

The present invention claims priority to provisional application 60/622,273, filed on Oct. 25, 2004, which is herein incorporated by reference in its entirety.

### BACKGROUND

1. Field of the Invention

The present invention is related to memory systems and, in particular, to a statistics engine.

2. Discussion of Related Art

Typically, memory systems are utilized to store packet information, route tables, link lists, and control plane table data in high speed communications applications. These systems often require significant statistical updates of the flow through of data in order to optimize the communication system and to enforce Service Level Agreements (SLA). However, performance of the statistical updates requires a significant amount of processor resources and therefore substantially decreases the packet throughput of nodes in a high-speed communications network.

FIG. 1 illustrates a typical network processing circuit. Packets are received from a plurality of input channels and framed in framer 101. Flow control manager (FCM) 102 directs the framed packets to content inspection engine (CIE) 103. CIE 103 directs the packets to network processing unit (NPU) 104. CIE 103 identifies the types of packets and their disposition so that they can be processed in NPU 104. NPU 104 transfers the packets to a second FCM 108 that can communicate with a switch fabric 109, which may involve switching output channel locations for various packets. Packets are then transferred back through FCM 108, NPU 104, CIE 103, and FCM 102 for transmission through framers 101. NPU 104 typically can be coupled with memories 106 and 107 as well as with a network search engine (NSE) 105. Controller 110 controls the operation of FCM 102, CIE 103, NPU 104, and FCM 108 and monitors the performance of network processing circuit 100.

In general, statistics and monitoring tasks are performed by NPU 104 and the data is communicated with controller 110. Such statistics as the number of bytes of information transferred on behalf of a particular customer or the error rate for transfer of data through network circuit 100 may be obtained. Compilation of such statistics can occupy a significant amount of the bandwidth of NPU 104. As a result of the utilization of the bandwidth of NPU 104 in performing statistics functions, the throughput of network circuit 100 can be substantially reduced.

Therefore, what is needed is a system that can perform the required statistical updates on data flowing through a system while not significantly decreasing the bandwidth of the processor handling the data flow.

### SUMMARY

In accordance with the invention, a memory system is presented that performs statistical functions on the data stored in a memory of the memory system with minimal utilization of the processor of the node. The memory system includes a dual-port memory with a statistics processor coupled to one of the two ports. The system processor for the node, then, can utilize the second port of the dual-port memory while the statistics processor is performing statistical updates on data stored in the memory. In some embodiments, the memory system can include a microprocessor or Arithmetic Logic Unit (“ALU”). In some embodiments, statistical information is communicated to a system processor through memory locations in the dual-port memory.

A statistics engine according to some embodiments of the present invention includes a dual-port memory array; and a statistics processor coupled to a first port of the dual-port memory array, wherein the statistics processor is capable of performing statistical updates of data stored in the dual-port memory array in response to commands received in the statistics engine. In some embodiments, the statistics processor includes an arithmetic logic unit, the arithmetic logic unit including counters where operations can be performed. In some embodiments, the statistics engine can include an address buffer, the address buffer being coupled to a decoder to interpret operational codes received in an address on a write command. In some embodiments, the statistics engine operates as a QDR memory. In some embodiments, counters in the statistics processor are configurable as to width. In some embodiments, the statistics engine can include a default registry. In some embodiments, default registers in the default registry are writeable. In some embodiments, the statistics engine includes configurations registers. In some embodiments, the configurations registers includes a register that controls the width configuration of the counters. In some embodiments, the configurations register includes a register that controls which of a plurality of opcode sets to execute in response to a particular opcode.

A method of performing statistics in a statistics engine according to the present invention includes receiving an operational code in a statistics engine, the statistics engine including a dual-port memory and a statistics processor coupled to a port of the dual-port memory; and performing an operation indicated by the operation code. In some embodiments, receiving an operational code includes receiving an address with the operational code embedded with a write command. In some embodiments, data can be received with the write command.

In some embodiments, performing an operation includes reading a value from the dual-port memory; incrementing the value by one; and writing the value into the dual-port memory. In some embodiments, performing an operation includes reading a value from the dual-port memory; decrementing the value by one; and writing the value into the dual-port memory. In some embodiments, performing an operation includes obtaining a first operand into an arithmetic logic unit; obtaining a second operand into the arithmetic logic unit; and providing a value resulting from a function of the first operand and the second operand. In some embodiments, the value can be written into the dual-port memory. In some embodiments, the function is chosen from a set of functions consisting of adding the first operand to the second operand; subtracting the first operand from the second operand; and performing an XOR operation between the first operand and the second operand. In some embodiments, obtaining the first operand includes receiving the first operand from a location in a set of locations consisting of a data input, a default register, the dual-port memory, and an output of the arithmetic logic unit. In some embodiments, obtaining the second operand includes receiving the second operand from a location in a set of locations consisting of a data input, a default register, the dual-port memory, and an output of the arithmetic logic unit. In some embodiments, the first operand and the second operand are received from locations determined by the operational code.

In some embodiments, performing an operation indicated by the operational code includes performing a virtual clear operation. In some embodiments, performing an operation indicated by the operational code includes simultaneously performing functions utilizing multiple counters. In some embodiments, performing an operation indicated by the operational code includes initializing settings registers. In some embodiments, initializing settings registers includes setting registers that determine a width configuration of counters in the statistics processor. In some embodiments, initializing settings registers includes setting registers that determine an opcode instruction set to be utilized in the statistics engine. In some embodiments, performing an operation indicated by the operation code includes initializing default registers. In some embodiments, performing an operation indicated by the operation code includes performing a statistics read operation.

These and other embodiments are further described below with respect to the following figures. It is to be understood that both the foregoing general description and the following detailed description are exemplary and explanatory only and are not restrictive of the invention, as claimed.

### BRIEF DESCRIPTION OF THE DRAWINGS

FIG. 1 illustrates an example conventional networking circuit.

FIG. 2A illustrates a statistics engine according to some embodiments of the present invention.

FIG. 2B illustrates a cascaded series of statistics engines according to some embodiments of the present invention.

FIG. 3 illustrates an example of a networking circuit utilizing a statistics engine according to some embodiments of the present invention.

FIGS. 4A through 4B illustrate various aspects of certain embodiments of statistics engines according to some embodiments of the present invention.

FIG. 5 illustrates variable configurations of a counter in some embodiments of statistics engine according to the present invention.

FIGS. 6A through 6C illustrate dual-counter implementations of a statistics engine according to some embodiments of the present invention.

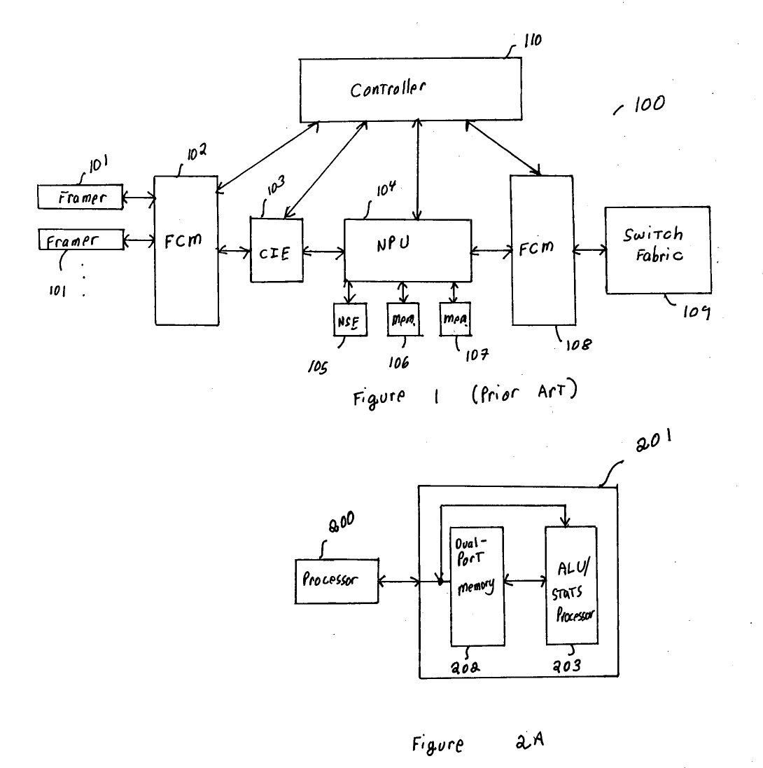

In the figures, elements having the same designations have the same or similar functions.

### DETAILED DESCRIPTION

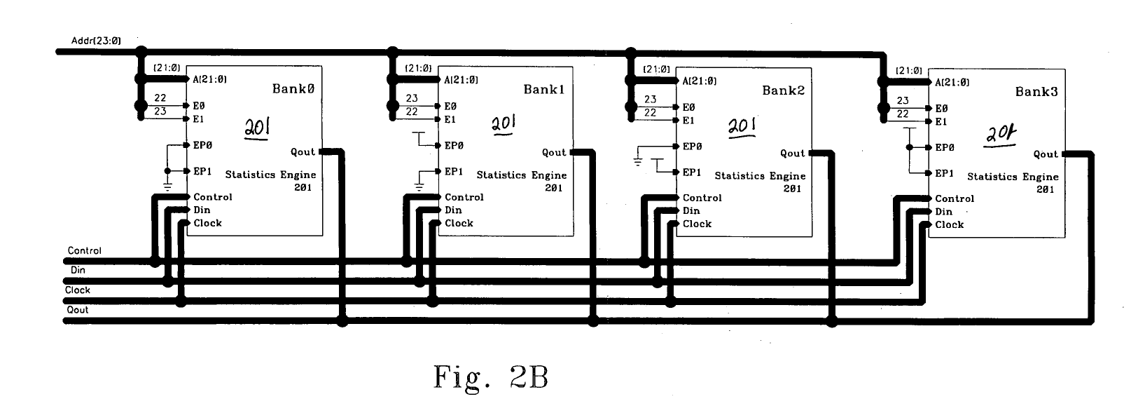

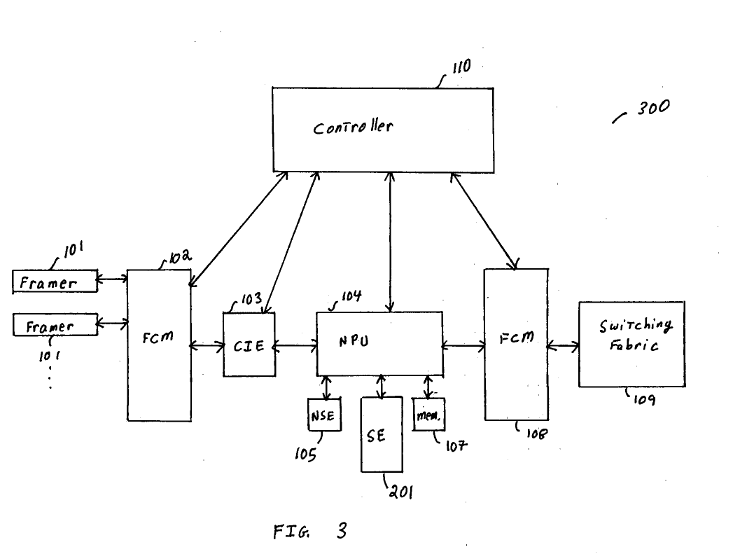

FIG. 2A illustrates a block diagram of a statistics engine 201 according to some embodiments of the present invention. As shown in FIG. 2A, statistics engine 201 includes a dual-port memory 202 coupled through one port to a statistics processor 203. The remaining port can be coupled to a processor 200 that can store data in dual-port memory 202 as if it were a single port memory system. Statistics processor 203 performs statistical analysis on data, such as packet data, stored in dual-port memory 202 and, in some embodiments, reports the results of such analysis by updating memory locations in dual-port memory 202.

Some embodiments of statistics engine 201 allow processor 200, which is coupled to statistics engine 201, to view statistics engine 201 as a single port memory system. However, processor 200 can be relieved of the duties to perform the statistical functions on the data that it is storing in statistics engine 201 that it would normally perform. Further, in some embodiments statistics processor 203 can update multiple counters and write to memory locations in dual-port memory 202 in response to a single command from processor 200. Significant improvement in the bandwidth of processor 200 coupled to statistics engine 201 can be attained. Statistics engine 201 can, then, be utilized in networking systems while providing greater packet throughput and more thorough statistical analysis of packet flow.

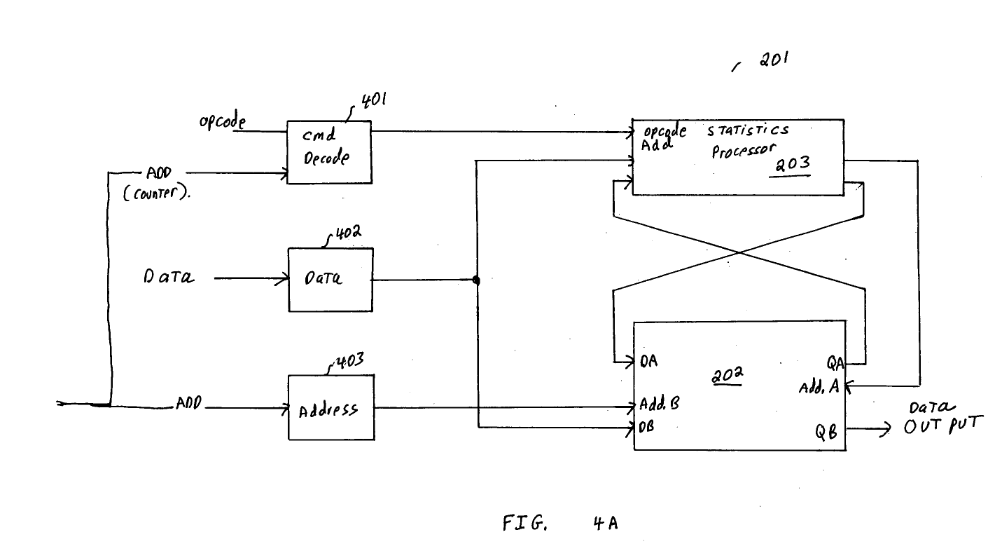

FIG. 3 illustrates utilization of an embodiment of statistics engine 201 in a network control circuit 300 according to the present invention. As shown in FIG. 3, a memory 106 is replaced by statistics engine 201. NPU 104 can then direct statistics engine 201 to perform the statistical tasks that would conventionally be performed on NPU 104. NPU 104 can then treat statistics engine 201 as a single port memory and still have the network packet statistics performed without significantly decreasing the processing bandwidth of NPU 104. Utilization of statistics engine 201, therefore, can greatly enhance the bandwidth of network circuit 300.

Although dual-port memory 202 shown in FIG. 2A can be any dual-port memory, in some embodiments of the present invention dual-port memory 202 can be a dual-port memory with Quad Data Rate (QDR) interface. Statistics engine 201, then, has the same interface as a QDR single-ported SRAM with the additional capability of performing arithmetic operations as well as logical operations. Further, although dual-port memory 202 can be of any physical size and row/column configuration, some embodiments can include, for example, a 1024K X 18 or 512K X 36 dual-port QDR memory.

FIG. 2B illustrates cascading of multiple statistic engines 201 and sample input pin configurations for statistics engine 201. Although four statistic engines 201 are cascaded in FIG. 2B, one skilled in the art will recognize that any number of statistics engines 201 can be cascaded. As shown in FIG. 2B, chip enable pins (E0 and E1) can be utilized as address pins to select one out of the four statistics engine 201 to be active. In the four-chip configuration shown in FIG. 2B, two chip enable pins are connected to Addr23 and Addr22, while the usual address pins A[21:0] are connected to Addr[21:0]. Addr[21:0] carries the opcode information and the address for the memory arrays in all four chips. In the embodiment shown in FIG. 2B, the chip enable polarity pins (EP0 and EP1) are used to program the polarity of the respective chip enable pins. When EP0 is connected to ground, E0 is active low. When EP0 is connected to power, E0 is active high. EP1 controls the polarity of E1 in a similar fashion. Hence, Bank0 will be selected only when Addr22=0 and Addr23=0. It can be seen that Addr23 and Addr22 are actually addressing the 4 statistics engine 201 (selecting one among Bank0, Bank1, Bank2 and Bank3). Of course, one skilled in the art will recognize that any arrangement of addresses and any size of address can be utilized in embodiments of statistics engine according to the present invention.

As shown in FIG. 2B, with two enable inputs, four statistics engines 201 can be cascaded. Any number of additional inputs can be utilized to control various functions of statistics engine 201. For example, a master reset input can be utilized to reset all of the counters in an individual statistics processor 203. In some embodiments, the master reset input can be asynchronous. In some embodiments, the master reset occurs when the input pin is held at a particular voltage over a predetermined number of clock cycles. In some embodiments, a master reset is performed on power-up in order that the counters and registers of each of statistics processors 203 are in a known state.

In some embodiments, data is transmitted in even parity in order to adhere to LA-1/NPU standards. However, in general, statistics engine 201 can receive and transmit data with any parity.

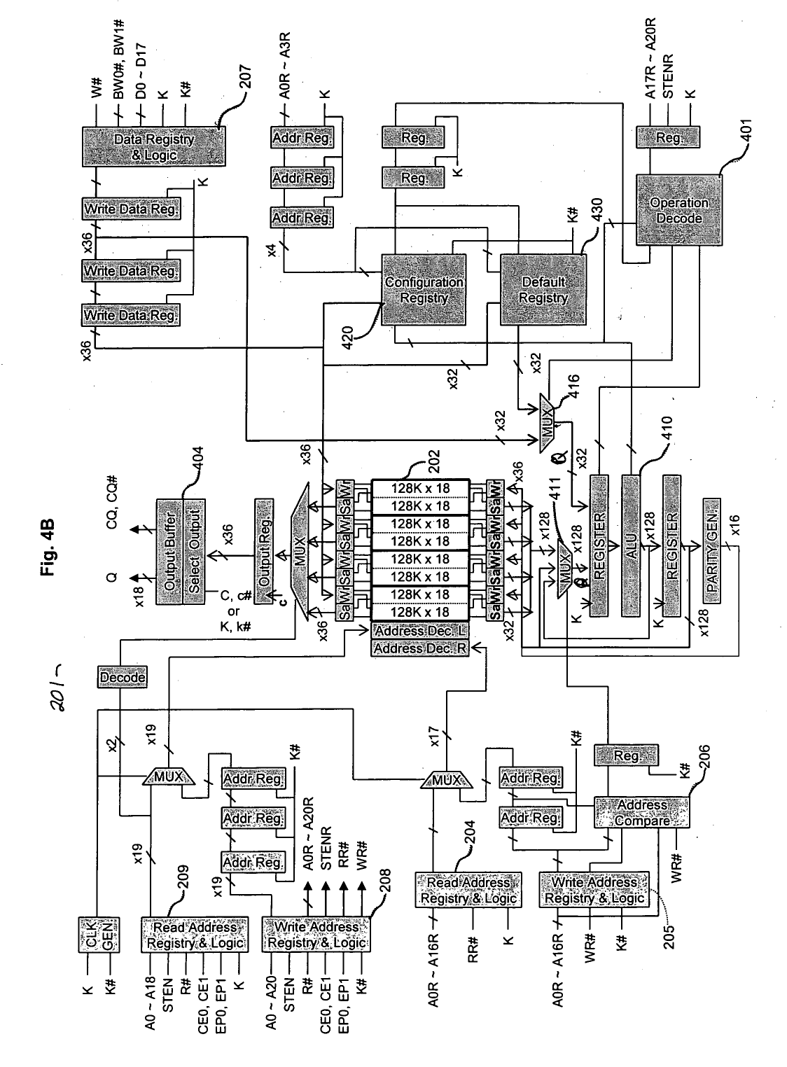

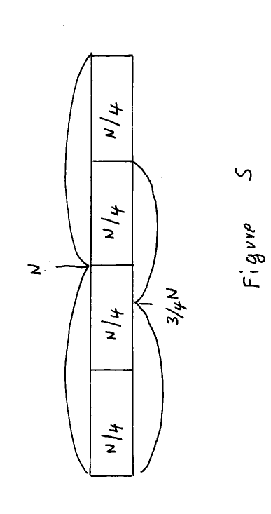

FIG. 4A illustrates an embodiment of a statistics engine 201 according to the present invention. As shown in FIG. 4A, statistics processor 203 is coupled to memory array 202 in order to read and write to memory array 202. Further, as shown in FIG. 4A, an input address is coupled to both a command decode 401 and address buffer 403. In some embodiments, opcodes to statistics processor 203 are transmitted in the address from processor 200. If processor 200 is accessing the statistics processor 203, the address/opcode are decoded in command decoder 401 and communicated to statistics processor 203 for implementation. Typically, address A of memory array 202 is a function of the ADD input to command decoder 401. If the processor is accessing memory array 202, then the input address is buffered in address buffer 403 and transmitted to an address input to dual-port memory array 202. Input data can be buffered in data buffer 402 and input to memory array 202 and statistics processor 203. Output data can be output from memory array 202 and, in some embodiments, can also be buffered before transmission to processor 200.

FIG. 4B illustrates an embodiment of statistics engine 201 according to the present invention. Statistics processor 203 can include arithmetic logic unit (ALU) 410 coupled to receive operand P through multiplexer 411 and operand Q through multiplexer 416. Multiplexer 411 selects operand P from dual-port memory array 202, ALU 410, or the registered output of ALU based on the result of address comparator 206. Multiplexer 416 selects operand Q from default registry 430 or input data from processor 200 through data register 207 based on the opcode decoded by operation decode 401. ALU 410 can perform numerous functions involving the input and stored data, for example, an addition of the input data with the stored data, a subtraction of the input data from the stored data, and logic functions involving the input and stored data.

One skilled in the art will recognize that the data can be of any number of bits. Further, memory array 202 can have any width. As an example only, in some embodiments, such as that specifically shown in FIG. 4B, data inputs and data outputs can be 18 bit inputs and outputs. In some embodiments, 36-bit data lines can be implemented internally. In some embodiments, memory array 202 can be 128 k by 144-bit cores. In some embodiments, memory array 202 can be 256 k by 72-bit core. In some embodiments, statistics processor 203 can operate with 144 or 72-bit busses between memory array 202 and ALU 410, as appropriate.

As discussed before, statistics engine 201 can have the same interface as a QDR memory adhering to the QDRII standard with two 18-bit data interfaces. Further, some embodiments of statistics engine 201 can supported a “fire and forget” statistics update mode, where a single write to statistics engine 201 triggers a read from memory array 202, followed by operation in ALU 410, followed by write to same location of memory array 202. Hence, the “fire and forget” update can accomplish a READ-MODIFY-WRITE cycle with a single write command where the address carries the information of the opcode and location of the update, and the data can carry the optional operand. Furthermore, each write operation can update multiple counters at the same time with various operations on each counter as determined by the opcode.

Dual-port memory array 202 can have any bit density, for example 9 or 18 Mb with 144- or 72-bit wide cores. Further, some embodiments of statistics engine 201 can support adjustable counter widths. For example, with a 144-bit internal core, statistics engine 201 can configure each of the 128-bit counters as two 64-bit counters, one 64-bit counter and two 32-bit counters, or four 32-bit counters. Some embodiments can configure counters (including 8-bit and 32-bit counters) in any combination of ways, which may or may not be programably set in statistics engine 201.

ALU 410 can support any operations and can perform those operations with any word size, for example 128 bit, 64 bit, 32 bit, or 16 bit configurations. ALU 410 can support increment, decrement, summation, subtraction operations as well as logic operations such as XOR, AND, OR, or other operations. Further, some embodiments of statistics engine 201 can support back-to-back updates at full clock speeds in which case operand Q can be taken from the output of ALU 410 rather than the memory array 202. Further, virtual real-time “Read and Reset” for polling and clearing counters can be performed in some embodiments.

For example, processor 200 can read a 64 bit counter in memory array 202 which has a value C[63:0]. Because the same counter can not be cleared in the same time it is read, issuing an ALU operation that subtracts C[63:0] from the counter will achieve the virtual real-time “Read and Reset” function. Note that between the counter read & ALU operation, the counter value could have been changed. Hence, a simple clear to zero ALU operation will not result in the desired function. Further, some embodiments of statistics engine 201 only have 36 bit data interface. Hence, it will require two write cycles to pass the value of C[63:0] to be subtracted. A “virtual clear” ALU operation can be implemented, which only requires one write cycle to perform the same task. Instead of subtracting C[63:0] from the current counter value CC[63:0], C[31:0] is subtracted from CC[31:0] while the upper 32 bits of the counter value are reset to zero. It will be obvious to one skilled in the art that CC[63:0]−C[63:0]=CC[31:0]−C[31:0] as long as CC[63:0]−C[63:0]<2ˆ32. This is a reasonable expectation for statistics accounting. In the rare case that the counter is working in a decreasing sense in the statistics function, a virtual “Read and Set” can be achieved assuming the initial value of the counter is with all bits equal to one. ˜C[31:0] is added to CC[31:0] while the upper 32 bits of the counter value are set to all one instead of zero ˜C[31:0]=C[31:0] with polarity of all bits reversed. In this case, the expectation is changed to C[63:0]−CC[63:0]<2ˆ32. Further, some embodiments of statistics engine 201 includes a master reset function and chip enables for depth expansion. As a result, in some embodiments, address bits 23 and 22 can be reserved to select among several statistics engines 201 while other bits can be reserved for statistics opcodes. For example, in some embodiments with a 24 bit address, bits 23 and 22 can be reserved for depth selection (i.e., selection of statistics array 201) while the next bits (bits 21 to 18, 17, or 16, for example) are utilized for statistics opcodes.

In some embodiments, statistics engine 201 can perform one or all of the following tasks: at any specific location in dual-port memory 202, for example, processor 200 can read and write data, increment the memory value by 1, sum an input data with the value of the memory value and save the result in the memory value, decrement the memory value by 1, subtract the input data from a memory value and store the results at the memory value, add a default value to a memory value, XOR input data with a memory value, clear a counter value to zero or perform a virtual clear on a counter. Processor 200 can also program the device configuration as well as define default add and subtract registers. Some embodiments of statistics engine 201 can perform further tasks and include additional operations than those suggested here. In general, some embodiments of statistics engine 201 can perform any combination of memory, arithmetic, and logic operations requested by a processor 200.

In some embodiments, statistics functions are executed upon receipt of a write command with the appropriate opcode embedded in the address field. Other embodiments of statistics engine 201 can utilize alternative methods of supplying opcode commands and data to statistics engine 201. A write command contains all pertinent address and data information for execution of a statistics function in ALU 410. As illustrated in FIG. 4B, for example, most statistics functions are atomic, that is, they require a complete read-modify-write sequence to implement.

If dual-port memory 202 is a SRAM core, standard QDR memory accesses (i.e., either a standard read or write request from processor 200) may be blocked by a pending statistics read or write operation from ALU 410. In other words, the read or write operation performed by processor 200 may collide with a read or write operation initiated by ALU 410. In some embodiments, a statistics “read hold-off” buffer can be utilized. A “read hold-off” buffer can be a first-in first-out (FIFO) that remembers all the read operations initiated by ALU 410 that will be executed during an idle standard memory read cycle. Further, even if the statistics read operation is executed, there may be pending write operations. Thus, an additional stats “write hold-off” buffer or FIFO may be utilized. One problem with this solution is that the timing for completion of a statistics operation becomes non-deterministic. Another logic circuit, then, can be utilized to notify processor 200 of completion of the statistics operation. Further, because of the indeterminate nature, the buffers may overflow before the pending read or write operations can be executed. If dual-port memory 202 is a dual-port RAM (DPRAM) core then the issue of collisions is resolved and no FIFOs or extra logic is necessary. Therefore, statistics operations can be sent to some embodiments of statistics engine 201 and the results returned within a determinate number of cycles, which is referred to as a “fire and forget” feature. In some embodiments, the standard memory write is delayed to have the same latency as the ALU initiated write. Hence, the write collision between standard memory write and a write initiated by a statistics command is substantially eliminated.

In some embodiments, statistics engine 201 can include a “set register” command, which can be utilized to set internal registers of statistics processor 203 and to set default counters. Once the user issues the “set reg” command with an opcode, the remaining bits of the address can be utilized to select specific registers. For example, default registry 430 can include default increment registers and default decrement registers that can be selected. In some embodiments, there may be multiple default registers in default registry 430 for each counter in ALU 410. To accommodate concurrent multiple counter operations with limited width in an input data field, operations can be performed with an input operand containing any number of partition within its bits (for example, in dual counter embodiments, a 32 bit input can be divided into two 16 bit operands, one for each counter).

Some embodiments of statistics engine 201 have only a limited number of bits in the data interface, such as, for example, 36 bits. This can present a synchronization problem for processor 200 in order to read the value of a 64-bit counter. Between the two read cycles that read the upper and lower 32-bit values of the counter, the value of the counter could have been updated by the ALU. Hence, in some embodiments a statistics read command (as indicated by the opcode received with the read address) can be implemented to take a “snap-shot” value of the counter, reading either the lowest or highest bit sections out on the first read cycles and subsequent sections on subsequent read cycles. For example, with a 64-bit counter and 32-bit interface, the lower 32 bits can be sent to output buffer 404 while the upper 32 bits are stored in an internal register. On the next matching statistics read command, the output sent to output buffer 404 in response will be reading from the internal register rather than from memory 202.

As discussed above, statistics engine 201 includes a dual-port memory array 202, which in the embodiment shown in FIG. 4B can be configured as an array of 128K X 18 cores. As is shown in FIG. 4B, read and write addresses are received in read address buffer 209 and write address buffer 208, respectively. Data is presented to data registry 207. In FIG. 4B, the read and write operations are performed on the left port of memory array 202. A statistics processor 203 is coupled to the right port of memory array 202. However, a processor can initiate and monitor statistic engine 201 through read and write operations.

A statistics engine according to the present invention can include a dual-port memory core 202 where one port interfaces with a statistics processor 203 that performs statistical operations and another port where memory operations are performed by an external processor 200. For example, in a 1-MEG X 18 QDRIIb2 statistics engine, and referring to FIG. 4B, the internal memory architecture of memory array 202 can include four 128K×36 dual-port memory arrays. Nineteen (19) address inputs (A0 to A18) can be input to the left port (read address 209) and therefore only accesses one of the four arrays for each read or write command, where address inputs A0 and A1 can be utilized to determine which array is to be accessed. The right port has 17 address inputs (A0 to A16 as shown with read address 204 and write address 205), which can access the entire four arrays in each read or write operation. A standard 1-MEG X 18 QDRIIb2 SRAM can have two clock inputs K and K#, two clock outputs C and C#, two echo outputs CQ and CQ#, 19 address inputs A0 to A18, 18 data inputs D0 to D17, 18 data outputs Q0 to Q17, one read input R#, one write input W#, and two byte write inputs BW0# and BW1#. The statistics engine has all of the standard inputs plus extra address inputs A19 to A20 and one extra control input STEN.

In the embodiment shown in FIG. 4B, statistics operations execute upon receiving a microprocessor write command with appropriate stats OPCODE within the address. One skilled in the art will recognize that a statistics function can be initiated in many ways. For example, the opcode can be communicated in the input data rather than the address. Furthermore, a statistics function can be initiated on a read rather than write commend.

The statistics write cycle is initiated by setting W# low on a rising edge of the clock signal K and setting STEN high at the following rising edge of clock signal K#. The addresses A0 to A16 and OPCODE A17 to A20 for the statistics write cycle is provided at the same rising edge of the clock signal K# that captures the signal STEN. Data inputs for statistics ALU operation is expected at the rising edge of clock signal K and K#, beginning at the same clock cycle of clock signal K that initiated the write cycle. The data captured in response to the clock signals K and K# is delivered to the ALU after the next rising edge of the next clock cycle of clock signal K (t+1). The OPCODE is delivered to operation decode and the output of operation decode is delivered to the ALU after the next rising edge of the next cycle of clock signal K (t+1). Following the statistics write command, the right port will perform memory read at a rising edge of the next cycle of clock signal K (t+1), then the memory output and the data input will be delivered to the ALU and the ALU will perform an appropriated statistics operation based on the opcode after the next rising edge of the next cycle of clock signal K (t+2). The output signals from the ALU together with a new parity bit will be sent to the right port write register and the right port will perform a self-timed write cycle after the next rising edge of the next cycle of clock signal K (t+3).

As discussed above, configuration registry 420 and default registry 430 can be initiated by statistics processor 203 by implementation of the correct opcodes. ALU 410 performs statistics functions and counter functions utilizing the registers and counters in statistics processor 203. In some embodiments, an external configuration can be performed to configure counters and registers. Furthermore, in some embodiments statistics engine 201 can include multiple sets of opcode functions. In such embodiments, the function executed by statistics engine 201 in response to a particular opcode can be determined by data stored in registers in configuration registry 420.

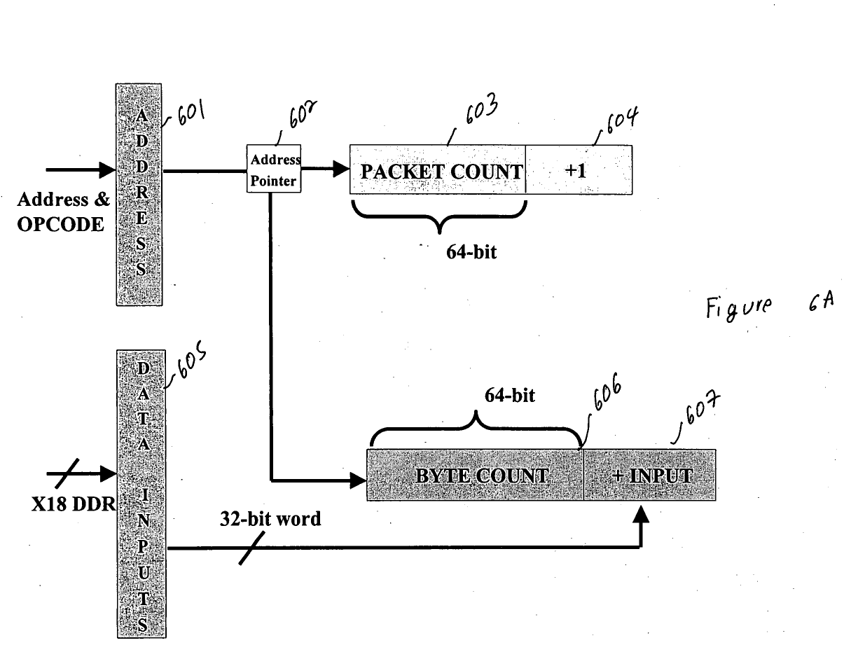

FIG. 5 illustrates configuring counters and registers in an embodiment of statistics engine 201 with a N-bit width. In some embodiments, N can be 128. As shown, the counter can be configured as four N/4 bit counters. Further, pairs of N/4 bit counters can be combined to form N/2 bit counters. Therefore, the counter can be configured as two N/2 bit counters, one N/2 bit counter and two N/4 bit counters, or four N/4 bit counters. In general, counters and registers can be configured in any fashion. A register in configuration registers 420 can select among these counter modes. Moreover, due to the limited width of the address field, the total number of available opcodes are limited in some of the embodiments. For example, some embodiments are limited to eight opcodes. Since one of the opcodes is used for “Set register” functions, the remaining seven can be insufficient to encompass all of the desirable opcodes for various applications. However, each application will have its optimized set of opcodes. Hence, by switching between different opcode sets through the configuration register setting, users can always pick the opcode set that best fits their operations without the need to increase the address field width.

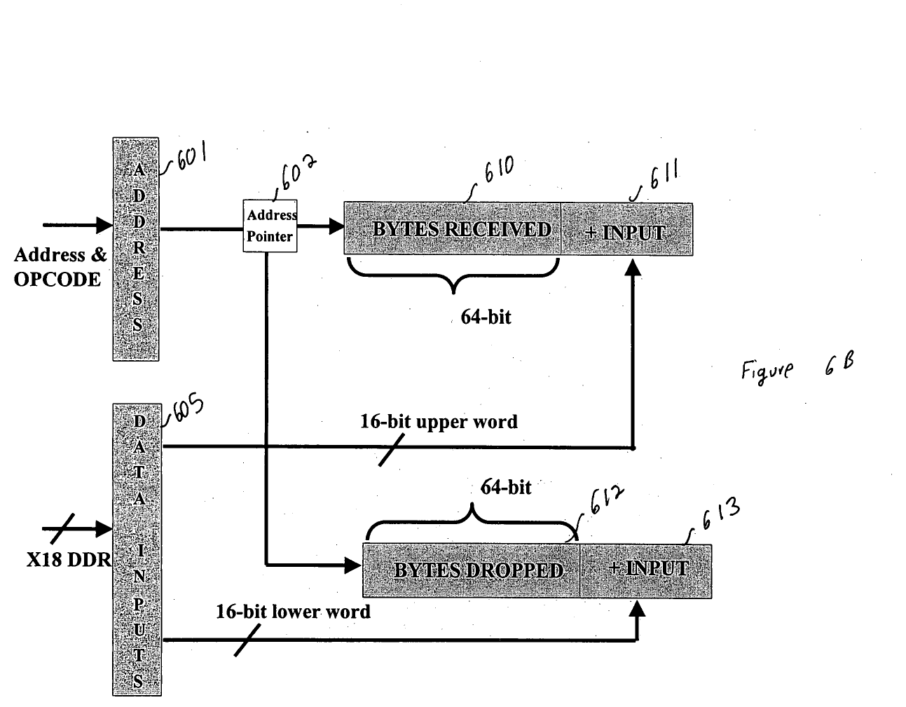

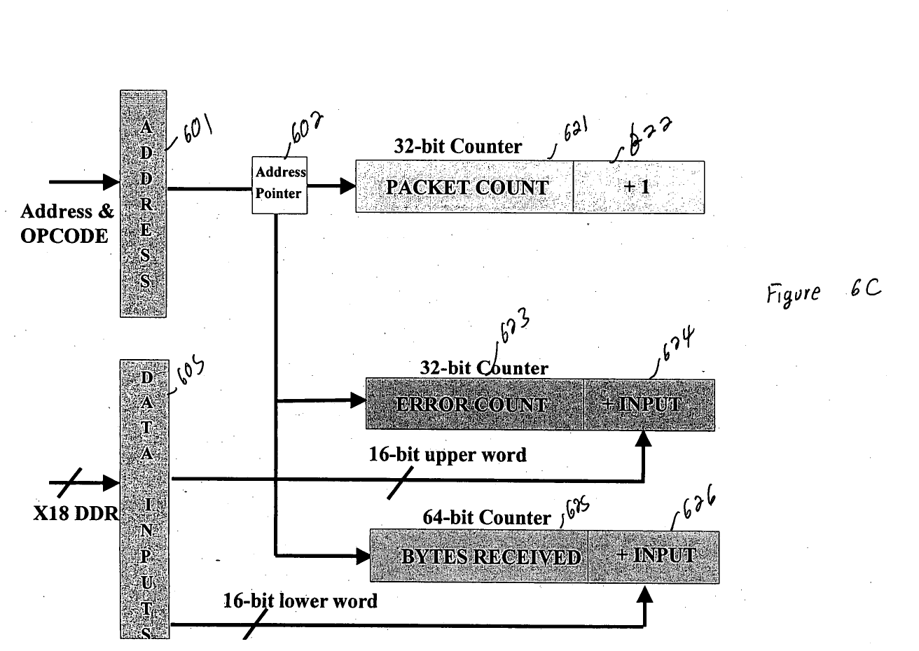

FIGS. 6A through 6C illustrate implementations of embodiments of statistics engine 201 for multiple counter applications. FIG. 6A, for example, illustrates a dual 64 bit counter configuration with a packet counter and a byte counter. An address with opcode is presented at address buffer 601 and data is presented at data input buffer 605. The address is decoded in address pointer 602 and a packet count counter 603 is incremented by one as is requested in operation field 604. Additionally, a byte count in byte count 606 is summed with the input data that is input into register 607. A read-modify-write operation on two 64-bit counters is accomplished with only one statistics write command.

In another dual 64-bit counter configurations, FIG. 6B illustrates calculation of bytes received and bytes dropped. Again, an address with the appropriate opcode is input to address buffer 601 and the address is identified in address pointer 602. Data is input to data input buffer 605 where the upper word indicates the number of bytes received while the lower word indicates the number of bytes dropped. The upper word is input to register 611 and added to bytes received 610 while the lower word is input to register 613 and added to the bytes dropped counter 612.

FIG. 6C illustrates an implementation of a three-counter configuration (in general, any number of individual counters can be implemented at once). Again, an address with the appropriate opcode is received in address buffer 601 and decoded in address pointer 602. Data is input to data input 605. In this case, the upper word of the data contains an error count while the lower word of the data contains the number of bytes received. In response to the operation, a packet count counter 621 is incremented by 1 as indicated in register 622, the upper word is input to register 624 and added to the existing error count in counter 623, and the lower word is input to register 626 and added to the bytes received counter 625.

An embodiment of a sample statistics engine according to some embodiments of the present invention is attached to this disclosure and herein incorporated by reference in its entirety. A description of that particular example embodiments, including particular opcode designations, is included in the attachment.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A statistics engine, comprising:
a dual-port memory array; and
a statistics processor coupled to a first port of the dual-port memory array,
wherein the statistics processor is capable of performing statistical updates of data stored in the dual-port memory array in response to commands received in the statistics engine.

2. The engine of claim 1, wherein the statistics processor includes an arithmetic logic unit, the arithmetic logic unit including counters where operations can be performed.

3. The engine of claim 1, further-including an address buffer, the address buffer being coupled to a decoder to interpret operational codes received in an address on a write command.

4. The engine of claim 1, wherein the statistics engine operates as a QDR memory.

5. The engine of claim 1, wherein counters in the statistics processor are configurable as to width.

6. The engine of claim 1, further including default registers.

7. The engine of claim 6, wherein the default registers are writeable.

8. The engine of claim 1, further including a configurations register.

9. The engine of claim 8, wherein the configurations register includes a register that controls the width configuration of counters in an arithmetic logic unit.

10. The engine of claim 8, wherein the configurations register includes a register that controls which of a plurality of opcode sets to utilize in response to a received opcode.

11. A method of performing statistics, comprising:
receiving an operational code in a statistics engine, the statistics engine including a dual-port memory and a statistics processor coupled to a port of the dual-port memory; and
performing an operation indicated by the operation code.

12. The method of claim 11, wherein receiving an operational code includes
receiving an address with the operational code embedded with a write command.

13. The method of claim 12, further including receiving data on an input data bus.

14. The method of claim 11, wherein performing an operation includes
reading a value from the dual-port memory;
incrementing the value by one; and
writing the value into the dual-port memory.

15. The method of claim 11, wherein performing an operation includes
reading a value from the dual-port memory;
decrementing the value by one; and
writing the value into the dual-port memory.

16. The method of claim 11, wherein performing an operation includes
obtaining a first operand into an arithmetic logic unit;
obtaining a second operand into the arithmetic logic unit; and
providing a value resulting from a function of the first operand and the second operand.

17. The method of claim 16, further including writing the value into the dual-port memory.

18. The method of claim 16, wherein the function is chosen from a set of functions consisting of adding the first operand to the second operand; subtracting the first operand from the second operand; and performing an XOR operation between the first operand and the second operand.

19. The method of claim 16, wherein obtaining the first operand includes receiving the first operand from a location in a set of locations consisting of a data input, a default register, the dual-port memory, and an output of the arithmetic logic unit.

20. The method of claim 16, wherein obtaining the second operand includes receiving the second operand from a location in a set of locations consisting of a data input, a default register, the dual-port memory, and an output of the arithmetic logic unit.

21. The method of claim 16, wherein the first operand and the second operand are received from locations determined by the operational code.

22. The method of claim 11, wherein performing an operation indicated by the operational code includes performing a virtual clear operation.

23. The method of claim 11, wherein performing an operation indicated by the operational code includes simultaneously performing functions utilizing multiple counters.

24. The method of claim 11, wherein performing an operation indicated by the operational code includes initializing settings registers.

25. The method of claim 24, wherein initializing settings registers includes setting registers that determine a width configuration of counters in the statistics processor.

26. The method of claim 24, wherein initializing settings registers includes setting registers that determine an opcode instruction set to be utilized in the statistics engine.

27. The method of claim 11, wherein performing an operation indicated by the operation code includes initializing default registers.

28. The method of claim 11, wherein performing an operation indicated by the operation code includes performing a statistics read operation.
